(19) United States
(12) Patent Application Publication
(10) Pub. No.: US 2016/0094315 A1
(43) Pub. Date: Mar. 31, 2016

(54) METHOD AND APPARATUS FOR TRANSMITTING AND RECEIVING PHYSICAL CHANNEL AND SIGNAL

(71) Applicant: Electronics and Telecommunications Research Institute, Daejeon (KR)

(72) Inventors: Taegyun NOH, Daejeon (KR); Young Jo KO, Daejeon (KR); Seung Chan BANG, Daejeon (KR)

(21) Appl. No.: 14/868,014

(22) Filed: Sep. 28, 2015

(30) Foreign Application Priority Data
Sep. 29, 2014 (KR) 10-2014-0130439
Oct. 1, 2014 (KR) 10-2014-0132484
Feb. 10, 2015 (KR) 10-2015-0020189
Sep. 25, 2015 (KR) 10-2015-0136378

(51) Int. Cl. H04L 1/18; H04L 5/14; H04W 72/04

(52) U.S. Cl. CPC H04L 1/1861; H04W 72/042; H04W 72/0413; H04W 72/0453; H04L 5/14; H04L 5/1469

(57) ABSTRACT

A method for transmitting a control channel including: receiving information regarding a format of the control channel from a base station (BS) through higher layer signaling; and transmitting a control channel mapped to at least one of a plurality of resource blocks positioned at both end portions of a system band to the BS through one slot on the basis of the information regarding the format of the control channel, and a method for performing a shortened hybrid automatic repeat request (HARQ) process, are provided.

### CROSS-REFERENCE TO RELATED APPLICATION

This application claims priority to and the benefit of Korean Patent Application Nos. 10-2014-0130439, 10-2014-0132484, 10-2015-0020189, 10-2015-0136378 filed in the Korean Intellectual Property Office on Sep. 29, 2014, Oct. 1, 2014, Feb. 10, 2015, and Sep. 25, 2015, the entire contents of which are incorporated herein by reference.

### BACKGROUND OF THE INVENTION

(a) Field of the Invention

The present invention relates to a method and apparatus for transmitting and receiving a physical channel and a signal in a wireless communication system.

(b) Description of the Related Art

In a long term evolution (LTE) wireless communication system, a transmission time interval (TTI) of a physical channel is a subframe. Here, one subframe may include two slots, and one slot may include a plurality of symbols. A subframe, a slot, and a symbol are all units of a radio resource defined in a time domain. Here, delay of data transmission and reception may be reduced by redefining a length of the TTI.

### SUMMARY OF THE INVENTION

The present invention has been made in an effort to provide a method and apparatus for transmitting and receiving a physical channel and a signal by a terminal and a base station (BS) of a wireless communication system on the basis of a redefined transmission time interval (TTI).

An exemplary embodiment of the present invention provides a method for transmitting a control channel of a terminal. The method for transmitting a control channel may include: receiving information regarding a format of the control channel from a base station (BS) through higher layer signaling; and transmitting the control channel to the BS through one slot on the basis of information regarding the format of the control channel, wherein the control channel is mapped to at least one of a plurality of resource blocks positioned at both end portions of a system band.

The control channel may be mapped to each of a first resource block positioned at one end portion among both end portions of the system band and a second resource block positioned at the other end portion among both end portions of the system band.

The plurality of resource blocks may be disposed in relatively same positions at both end portions of the system bandwidth in units of N number of resource blocks having continuous indices.

When the N is 2, relative positions of two resource blocks having continuous indices may be determined according to whether the two resource blocks are of an even number or an odd number.

On the basis of an index of an i-th resource block among the N number of resource blocks having continuous indices and a modulo operation of N, a relative position of the i-th resource block with respect to the N number of resource blocks may be determined.

The transmitting may include, when reception performance of the control channel is poor, transmitting the control channel to the BS through one slot and a subsequent slot on the basis of information regarding a format of the control channel.

The receiving may include receiving information regarding a format of the control channel from the BS through radio resource control (RRC) signaling or system information.

Another exemplary embodiment of the present invention provides a method for performing a hybrid automatic repeat request (HARQ) process by a terminal. The method for performing a HARQ process may include: receiving a signal from a base station (BS) in a first slot among a plurality of slots included in a frame; when the terminal operates in a frequency division duplex (FDD) system, performing a HARQ process of the FDD system on the signal in units of four slots among the plurality of slots; and when the terminal operates in a time division duplex (TDD) system, performing a HARQ process of the TDD system on the signal in units of five slots among the plurality of slots.

The performing of the HARQ process of the FDD system may include: when the signal is a first physical downlink shared channel (PDSCH), transmitting an uplink ACK or NACK to the BS in a second slot spaced apart from the first slot by one slot; and after the uplink NACK is transmitted, receiving a second PDSCH corresponding to the first PDSCH in a third slot spaced apart from the second slot by one slot.

The performing of the HARQ process of the FDD system may include: when the first signal is a downlink ACK or NACK or uplink scheduling information, transmitting a PDSCH to the BS in a second slot spaced apart from the first slot by one slot; and receiving a downlink ACK or NACK or uplink scheduling information from the BS in a third slot spaced apart from the second slot by one slot.

The performing of the HARQ process of the TDD system may include: when the first slot is a downlink slot or a special slot and the signal is a first PDSCH, transmitting an uplink ACK or NACK to the BS in a second slot spaced apart from the first slot by one slot; and after the uplink NACK is transmitted to the BS, receiving a second PDSCH corresponding to the first PDSCH in a third slot spaced apart from the second slot by two slots.

When the first slot is a downlink slot, the third slot may be a downlink slot, and when the first slot is a special slot, the third slot may also be a special slot.

The performing of the HARQ process of the TDD system may include: when the first slot is a special slot and the signal is the downlink ACK or NACK or uplink scheduling information, transmitting the PUSCH to the BS in a second slot spaced apart from the first slot by one slot; and receiving an uplink ACK or NACK or uplink scheduling information in a special slot positioned to be subsequent to the second slot.

The performing of the HARQ process of the TDD system may include: when the first slot is a downlink slot and the signal is the downlink ACK or NACK or uplink scheduling information, transmitting a PUSCH to the BS in a second slot spaced apart from the first slot by one slot; and receiving a downlink ACK or NACK or uplink scheduling information in a downlink slot positioned to be subsequent to the second slot.

### BRIEF DESCRIPTION OF THE DRAWINGS

FIG. 1 is a view illustrating a physical uplink control channel of a wireless communication system according to an exemplary embodiment of the present invention.

FIGS. 2 to 4 are views illustrating physical uplink control channels of a wireless communication system according to an exemplary embodiment of the present invention.

FIG. 5 is a view illustrating a physical down link control channel according to an exemplary embodiment of the present invention.

FIG. 6 is a view illustrating a frame structure of a frequency division duplexing (FDD) system according to an exemplary embodiment of the present invention.

FIG. 7 is a view illustrating a frame structure of a time division duplex (TDD) system according to an exemplary embodiment of the present invention.

FIGS. 8 and 9 are views illustrating physical broadcast channels and synchronization signals included in a single slot transmission time interval (TTI) frame according to an exemplary embodiment of the present invention.

FIG. 10 is a view illustrating downlink hybrid automatic repeat request (HARQ) timing and uplink HARQ timing of the FDD system according to an exemplary embodiment of the present invention.

FIG. 11 is a view illustrating downlink HARQ timing of a TDD system according to an exemplary embodiment of the present invention.

FIG. 12 is a view illustrating uplink HARQ timing of a TDD system according to an exemplary embodiment of the present invention.

FIG. 13 is a block diagram illustrating a wireless communication system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a terminal may refer to a mobile station (MS), a mobile terminal (MT), an advanced mobile station (AMS), a high reliability mobile station (HR-MS), a subscriber station (SS), a portable subscriber station (PSS), an access terminal (AT), or user equipment (UE), and may include the entirety or a portion of functions of the MT, MS, AMS, HR-MS, SS, PSS, AT, or UE.

Also, a base station (BS) may refer to an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (ARS) serving as a base station, a high reliability relay station (HR-RS) serving as a base station, small base stations (BSs) (e.g., a femto base station (BS), a home node B (HNB), a home eNodeB (HeNB), a pico BS, a metro BS, a micro BS, etc.), and the like, and may include the entirety or a portion of functions of an ABS, a node B, an eNodeB, an AP, an RAS, a BTS, an MMR-BS, an RS, an RN, an ARS, an HR-RS, a small BS, and the like.

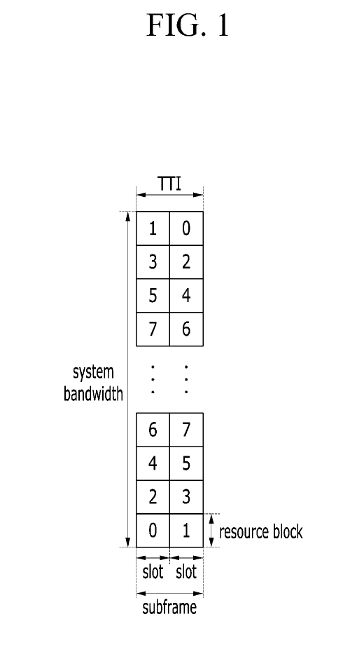

FIG. 1 is a view illustrating a physical uplink control channel of a wireless communication system according to an exemplary embodiment of the present invention.

Referring to FIG. 1, a physical uplink control channel (PUCCH) may be transmitted during one subframe, and each subframe includes two slots in a time domain. Each slot may include a plurality of resource blocks, which are resource units defined in time and frequency domains, and the PUCCH may be transmitted through one resource block. In FIG. 1, numbers illustrated in the resource blocks, respectively, denote indices of the resource blocks, and resource blocks having the same index are included in different slots.

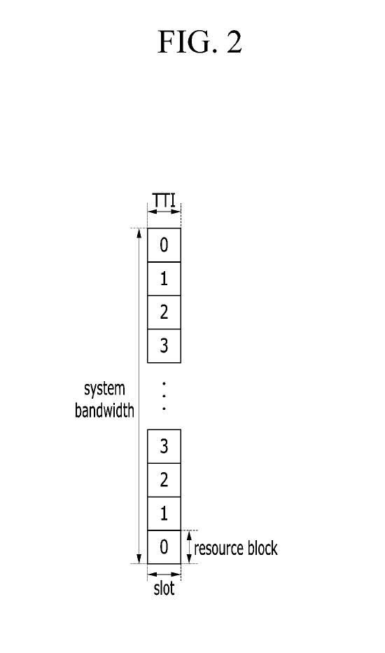

FIGS. 2 to 4 are views illustrating physical uplink control channels of a wireless communication system according to an exemplary embodiment of the present invention.

First, a base station (BS) according an exemplary embodiment of the present invention may serve as a cell control device controlling one cell. Thus, parameters differently allocated to cells may be allocated with different values by each BS. Also, in an actual communication system, one physical BS may control a plurality of cells, and the physical BS may include a plurality of BSs according to an exemplary embodiment of the present invention.

Referring to FIGS. 2 to 4, the PUCCH according to an exemplary embodiment of the present invention may be transmitted in two resource blocks during one slot. That is, since the wireless communication system according to an exemplary embodiment of the present invention has a single slot transmission time interval (TTI) frame structure, an uplink control signal such as the PUCCH may also be transmitted through one slot. Resource blocks to which the same PUCCH is mapped are denoted by the same index, and two resource blocks to which one PUCCH is mapped are positioned at both end portions of a system band in order to obtain a frequency diversity gain. Referring to FIGS. 2 to 4, one PUCCH according to an exemplary embodiment of the present invention may be mapped to four resource blocks positioned at both end portions of a system band, and a total of four PUCCHs may be transmitted through one slot.

Referring to FIG. 2, the resource blocks with PUCCHs mapped thereto are disposed in order of indices inwardly from an outer side of the system band. The disposition orders of the resource blocks are the same at both end portions. That is, resource blocks #0 are disposed in the outermost positions of the system bandwidth, resource blocks #1 are disposed inwardly in first positions of the system bandwidth, resource blocks #2 are disposed inwardly in second positions, and resource blocks #3 are disposed inwardly in third positions.

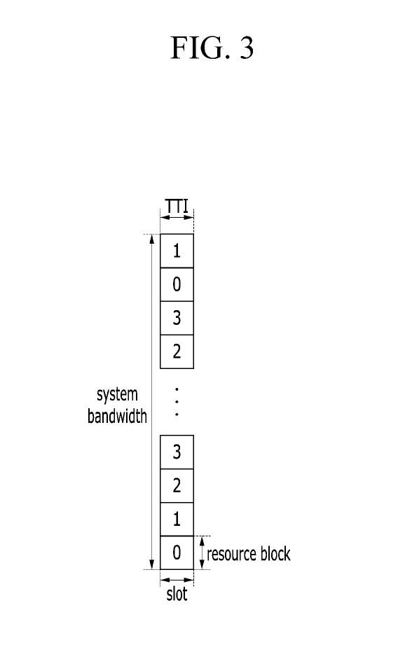

Referring to FIG. 3, resource blocks with PUCCHs mapped thereto are disposed such that each of two resource blocks having continuous indices is disposed in the same positions at both end portions of a system bandwidth. Relative positions of two resource blocks positioned at one end portion of the system bandwidth are also the same at the other end portion of the system bandwidth. For example, in FIG. 3, resource blocks #0 (even-number index) are disposed below resource blocks #1 (odd-number index), and this is applied in the same manner at both end portions of the system bandwidth. Also, in FIG. 3, resource blocks #3 (odd-number index) are positioned above resource blocks #2 (even-number index), and this is applied in the same manner at both end portions of the system bandwidth. That is, when the resource blocks with PUCCHs mapped thereto are disposed in units of two resource blocks, relative positions of two resource blocks may be determined depending on whether an index of each resource block is an even number or an odd number.

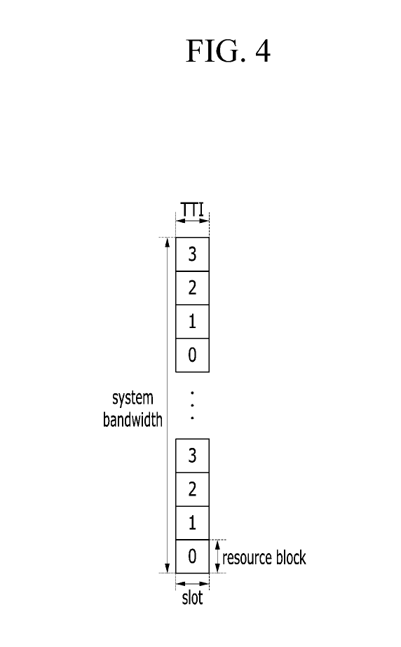

Meanwhile, resource blocks in which PUCCHs are transmitted may be disposed such that N number of resource blocks having continuous indices are disposed in the relatively same positions at both end portions of a system bandwidth. Relative positions of the N number of resource blocks positioned at one end portion of the system bandwidth may be the same at the other end portion of the system bandwidth. For example, in FIG. 4, resource blocks #0, #1, #2, and #3 are disposed in the same order in a vertical direction at both end portions of a system bandwidth. That is, resource blocks #0 are disposed in the lowermost positions among four continuous resource blocks, resource blocks #1 are disposed above the resource blocks #0, resource blocks #2 are disposed above the resource blocks #1, and resource blocks #3 are disposed in the uppermost positions among the four resource blocks with continuous indices. Here, relative positions of the N number of resource blocks with continuous indices may be defined by a modulo operation with respect to indices of the resource blocks. Referring to FIG. 4, when the modulo operation is performed by N number of resource blocks (N=4 in FIG. 4) having continuous indices (i mod N) with respect to index i of resource blocks, relative positions of the resource blocks having the index I with respect to the N number of resource blocks in a group may be determined on the basis of the result of the modulo operation. For example, in FIG. 4, when the modulo operation is performed on the resource block having an index 2 by 4, 2 is drawn, and thus a resource block having an index 2 may be disposed in the third position among the four resource blocks.

Here, when signal strength of a PUCCH received by a BS is high according to a location of a terminal or a channel environment, the PUCCH may be mapped only to a resource block (i.e., one resource block) positioned at one end portion, among both end portions, of the system bandwidth. Alternatively, in a case in which a terminal is positioned at a distance from a BS or in a case in which reception performance of a PUCCH is poor due to a limitation of transmission power according to a channel environment between the terminal and the BS, the PUCCH may be mapped to resource blocks positioned at both ends of the system bandwidth (i.e., four resource blocks) during two slots.

In an exemplary embodiment of the present invention, information regarding a format of a PUCCH may be transmitted through higher layer signaling from a BS to a terminal. The higher layer signaling may be radio resource control (RRC) signaling or system information. A format of a PUCCH may differ in each terminal or in each cell according to higher layer signaling. Cells may be identified through physical cell identifiers or through virtual cell identifiers.

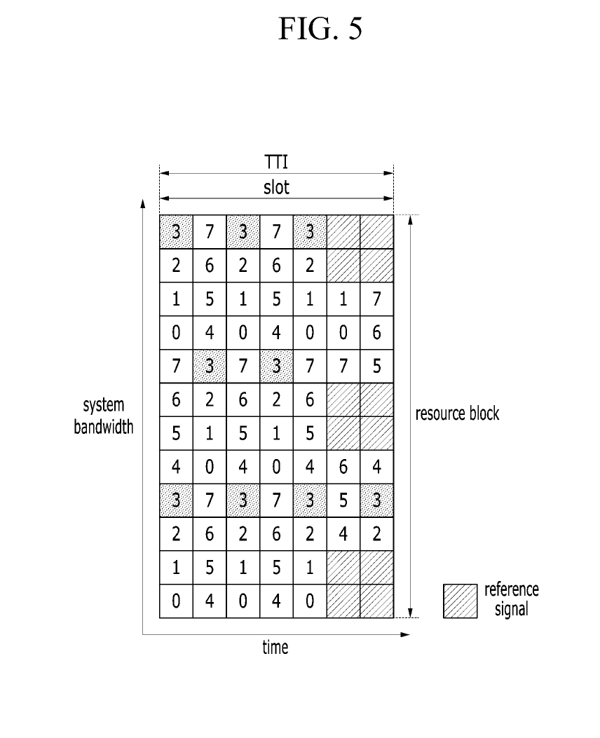

FIG. 5 is a view illustrating a physical down link control channel according to an exemplary embodiment of the present invention.

Referring to FIG. 5, a physical downlink control channel (PDCCH) according to an exemplary embodiment of the present invention may include a plurality of control channel elements (CCEs). Each of the CCE includes a plurality of resource element groups (REGs), and each of the REGs includes a plurality of reference elements (REs). Positions of REGs included in one resource block are the same in each resource block.

Referring to FIG. 5, one resource block includes twelve REGs in a frequency axis and seven REGs in a time axis. Each of the REGs is indexed and includes nine resource elements (REs).

An aggregation level refers to the number of CCEs forming a PDCCH. For example, when an aggregation level is 2, one PDCCH includes two control channel elements. When the aggregation level increases, a coding rate of a PDCCH is lowered, so that a terminal may successfully demodulate the PDCCH even when strength of a signal received by the terminal is low. That is, for example, in a case in which signal strength of a PDCCH received by the UE is high, the terminal may successfully demodulate the PDCCH even at a low aggregation level, and when signal strength of the PDCCH is low, the terminal needs to use a high aggregation level to successfully demodulate the PDCCH. Also, the terminal may perform blind decoding while changing an aggregation level with respect to the PDCCH, and here, the number of blind decodings performed by the terminal may vary according to each aggregation level.

There are a basic combination of an aggregation level of a PDCCH and a blind demodulation number regarding each aggregation level, and an additional combination of an aggregation level for a terminal having low signal strength of a PDCCH and a blind demodulation number regarding each aggregation level. Compared with the basic combination, the additional combination may have a different aggregation level and have the same blind demodulation number regarding each aggregation level. Alternatively, the additional combination may have a different basic combination and a different blind demodulation number regarding each aggregation level.

In an exemplary embodiment of the present invention, the BS may inform information to the terminal regarding whether the combination of an aggregation level of the PDCCH and the blind demodulation number regarding each aggregation level is a basic combination or an additional combination through higher layer signaling. The higher layer signaling may be RRC signaling or system information. An aggregation level of a PDCCH received by the terminal and the blind demodulation number may differ in terminals or cells according to higher layer signaling.

According to an exemplary embodiment of the present invention, in the basic combination, an aggregation level is {1, 2, 4, 8} and a blind demodulation number regarding each aggregation level is {6, 6, 2, 2}. In an additional combination, the aggregation level is {2, 4, 8, 16} and the demodulation number regarding each aggregation level {6, 6, 2, 2}. Whether an aggregation level is {1, 2, 4, 8} or {2, 4, 8, 16} may be identified through higher layer signaling. When the terminal is away from the BS, the terminal may require a format of a PUCCH transmitted during two slots. Also, the terminal away from the BS may require a combination of a high aggregation level and a high blind demodulation number with respect to a PDCCH. Thus, the BS may inform the terminal about a format of the PDCCH and a combination of an aggregation level of the PDCCH and a blind demodulation number through one higher layer signaling. Here, the higher layer signaling may be RRC signaling or system information.

The PDCCH may include control information regarding a physical downlink data channel (PDDCH) and a physical uplink data channel (PUDCH), and the control information includes information regarding resource allocation. The information regarding resource allocation includes information regarding frequency domain resource for a PDDCH and a PUDCH transmitted in one slot. Since one PDDCH and one PUDCH each are transmitted in one slot, two PDCCHs are required to transmit control information regarding the PDDCH and PUDCH transmitted in two slots. In an exemplary embodiment of the present invention, in order to reduce overhead of PDCCHs, one PDCCH may transmit control information regarding the PDDCH and the PUDCH transmitted during two slots. Here, the number of slots of the PDDCH and the PUDCH transmitted in two slots may be one or two. In a case in which the number of the PDDCH and the PUDCH transmitted in two slots is two, the two PDDCH and the PUDCH may be scheduled in the same manner according to one PDCCH.

A BS according to an exemplary embodiment of the present invention may provide information regarding the number of slots of the PDDCH and the PUDCH to which one PDCCH is applied to the terminal through higher layer signaling. The higher layer signaling may be RRC signaling or system information. The number of slots of the PDDCH and the PUDCH to which the PDCCH may be varied for each terminal or each cell according to higher layer signaling. Here, cells may be identified through physical cell identifiers or may be identified through virtual cell identifiers.

A BS according to another exemplary embodiment of the present invention may provide information regarding the number of slots of the PDDCH and the PUDCH to which one PDCCH is applied, to the terminal through physical layer signaling. The physical layer signaling may be a bit field defined in control information of a PDCCH. The bit field defined in the control information of the PDCCH may be an existing field which has been defined, or may be a bit field newly defined to provide information regarding the number of slots of the PDDCH and the PUDCH. Alternatively, the physical layer signaling may be a mask of a cyclic redundancy check (CRC) applied to the PDCCH.

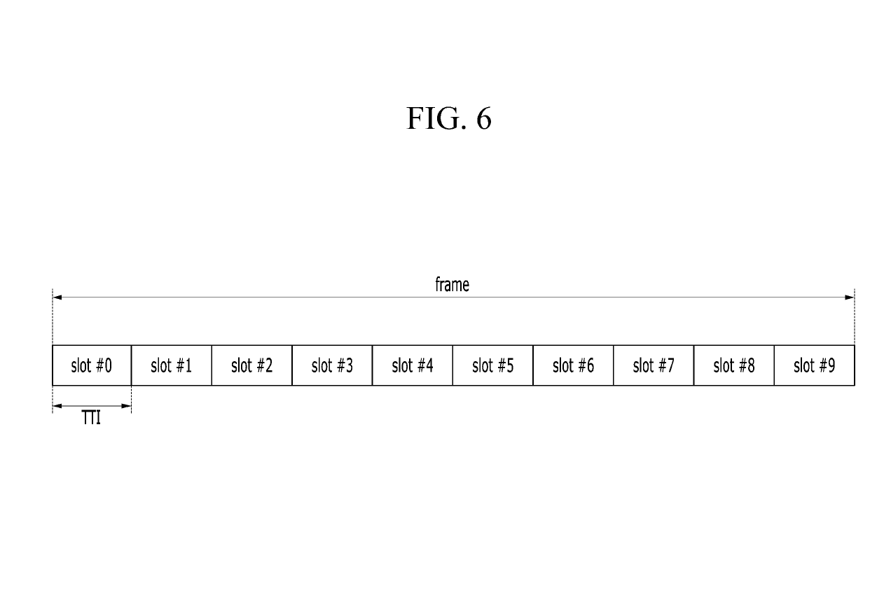

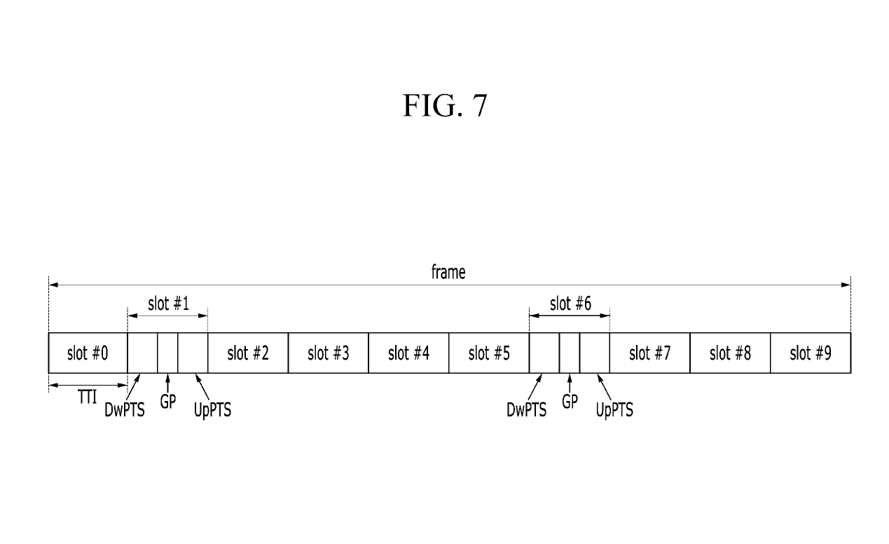

FIG. 6 is a view illustrating a frame structure of a frequency division duplexing (FDD) system according to an exemplary embodiment of the present invention, and FIG. 7 is a view illustrating a frame structure of a time division duplex (TDD) system according to an exemplary embodiment of the present invention.

Referring to FIG. 6, the FDD system has a single slot TTI frame structure. That is, in the FDD system according to an exemplary embodiment of the present invention, one frame includes ten slots.

Referring to FIG. 7, the TDD system according to an exemplary embodiment of the present invention also has a single slot TTI frame structure. In the frame of the TDD system, slot #0 and slot #5 are downlink slots. Slot #1 and slot #6 are special slots which include a downlink pilot time slot (DwPTS), a guard period (GP), and an uplink pilot time slot (UpPTS). The other slots (slot #2, slot #3, slot #4, slot #7, slot #8, and slot #9) included in the frame of the TDD system may be downlink slots or uplink slots.

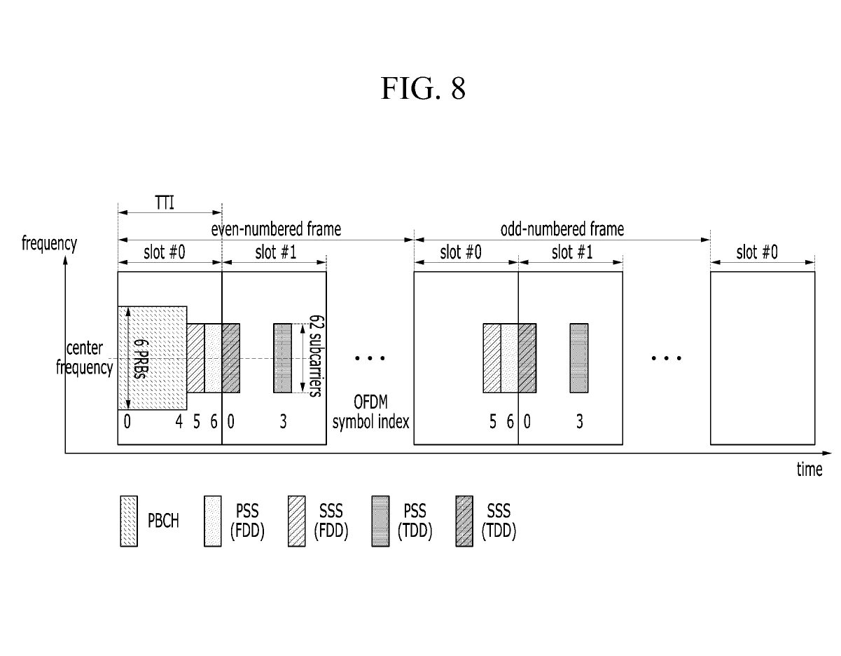

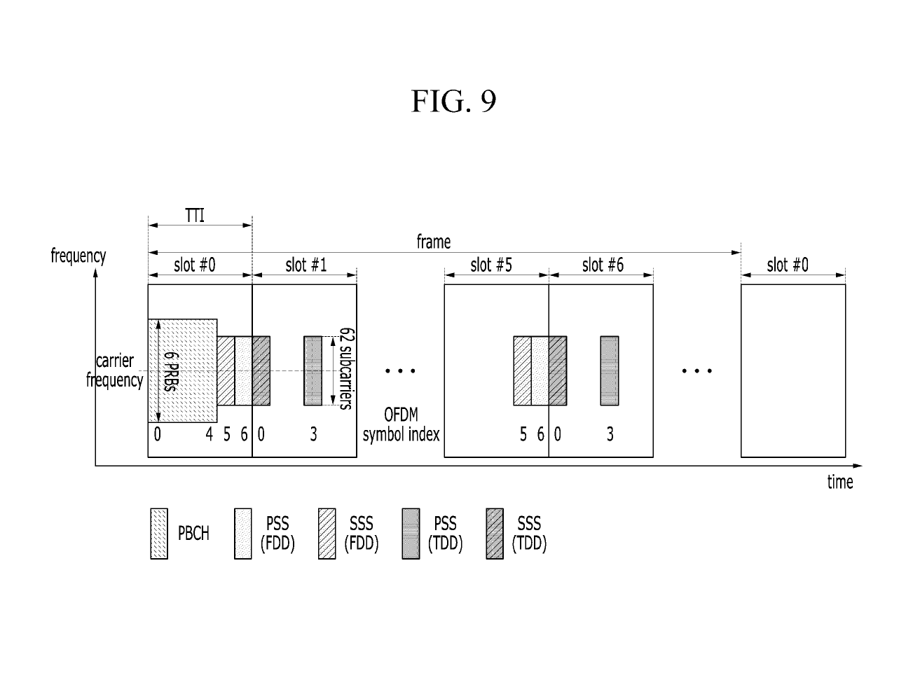

FIGS. 8 and 9 are views illustrating physical broadcast channels and synchronization signals included in a single slot transmission time interval (TTI) frame according to an exemplary embodiment of the present invention.

In a single slot TTI, a physical broadcast channel (PBCH) and a synchronization signal (SS) may be disposed to be different from those of a related art system. The SS may include a primary SS (PSS) and a secondary SS (SSS). The SS may be transmitted through sixty-two subcarriers in a frequency domain, and may be transmitted through one orthogonal frequency division multiplexing (OFDM) symbol in a time domain.

Referring to FIGS. 8 and 9, the PBCH may be disposed in the same manner in the FDD and the TDD. The PBCH is a downlink channel, and thus, in the TDD, the PBCH may be transmitted in slot #0, slot #1, slot #5, and slot #6 guaranteeing downlink transmission. Here, since one or less PBCH is transmitted in one frame, the PBCH may be transmitted in slot #0 or slot #1 in consideration of a period of the PBCH. Also, slot #1 is a special slot in which a length of DwPTS is variable, and thus, in an exemplary embodiment of the present invention, the PBCH may be transmitted in slot #0.

Referring to FIG. 8, according to the period of the PBCH, the PBCH may be transmitted only in the even-numbered frame and may not be transmitted in an odd-numbered frame. Referring to FIG. 9, the PBCH may be transmitted in slot #0 of every frame.

Referring to FIGS. 8 and 9, the PBCH may be transmitted through six resource blocks on the basis of a carrier frequency in the frequency domain. Also, the PBCH may be transmitted from OFDM symbol #0 to OFDM symbol #4 in the time domain.

The SS may be transmitted in different positions in the frame of the FDD system and in the frame of the TDD system. Since the SS is a downlink channel, the SS may be transmitted in slot #0, slot #1, slot #5, and slot #6 guaranteeing downlink transmission in the TDD system. Here, in consideration of a period of the SS, the PSS and the SSS may be transmitted one time or less in one frame, and thus the PSS and the SSS may be transmitted in slot #0 or slot #1. Similarly, slot #1 is a special slot in which a length of DwPTS is variable, and thus the SS may be transmitted in a symbol at a front portion of slot #1. Referring to FIG. 8, the SSS of the TDD system is transmitted in symbol #0 of slot #1 of each frame, and the PSS of the TDD system is transmitted in symbol #3 of the slot #1 of each frame. That is, two OFDM symbols are present between the SSS and the PSS. Referring to FIG. 9, the SSS of the TDD system is transmitted in symbol #0 of slot #1 and slot #6 of each frame, and the PSS of the TDD system is transmitted in symbol #3 of slot #1 and slot #6 of each frame. In FIG. 9, a frame structure regarding a case in which periods of the PBCH and the SS have a short period is illustrated. Referring to FIG. 9, the PBCH is transmitted once in every frame, and the SS is transmitted twice in every frame.

In the FDD system, the SS may be transmitted in symbol #5 and symbol #6 of slot #0. Referring to FIG. 8, the SSS of the FDD system in symbol #5 of slot #0 of an even-numbered frame of the FDD system, and the PSS is transmitted in symbol #6 of slot #0 of the even-numbered frame of the FDD system. Here, the PBCH may be transmitted from symbol #0 to symbol #4 (five symbols) of slot #0. Referring to FIG. 9, the SS of the FDD system may be transmitted in slot #0 and slot #5 of a frame of the FDD system. That is, the SSS and the PSS are transmitted through symbol #5 and symbol #6 of slot #0 of each frame of the FDD system, and the SSS and the PSS may be transmitted through symbol #5 and symbol #6 of slot #5 of each frame of the FDD system.

In the FDD system and the TDD system, commonly, SSSs transmitted in the even-numbered frame and the odd-numbered frame may be different. Referring to FIG. 8, the SSS transmitted in the even-numbered frame in which the PBCH is transmitted may be different from the SSS transmitted in the odd-numbered frame in which the PBCH is not transmitted.

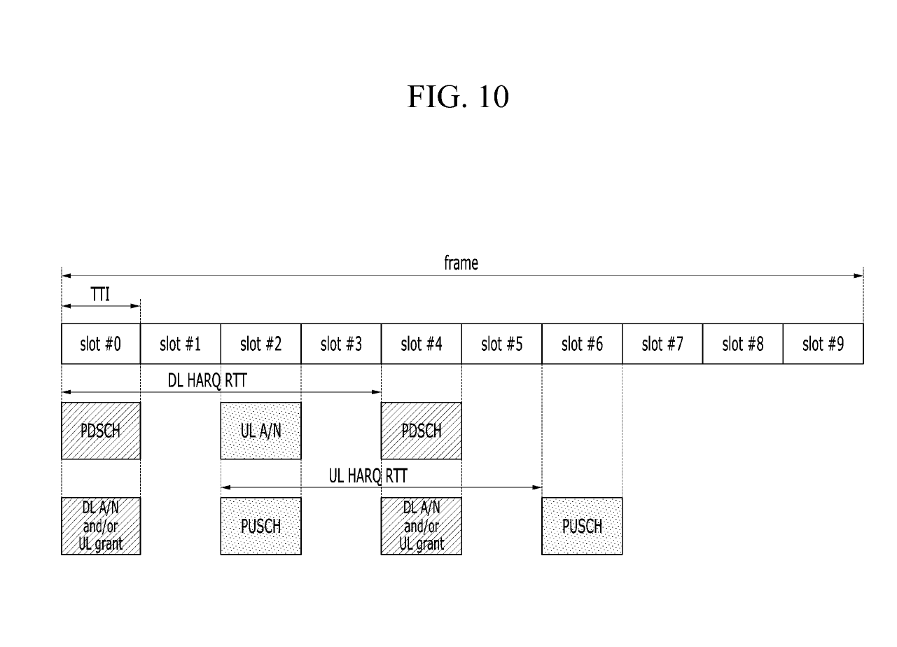

FIG. 10 is a view illustrating a downlink hybrid automatic repeat request (HARQ) timing and an uplink HARQ timing of the FDD system according to an exemplary embodiment of the present invention.

In a single slot TTI, a timing of a HARQ is different from that of an existing system. The downlink HARQ timing is as follows. A terminal transmits a physical downlink shared channel (PDSCH) from a BS, and transmits an uplink ACK/NACK (A/N) to the BS after one slot. Upon receiving the uplink A/N from the terminal, the BS transmits a PDSCH after one slot. Here, when the BS receives the uplink NACK from the terminal, the BS may retransmit a PDSCH corresponding to the previously transmitted PDSCH. That is, when the unlink NACK is received by the BS, a PDSCH for correcting an error of the previously transmitted PDSCH may be transmitted from the BS to the terminal. In the FDD system according to an exemplary embodiment of the present invention, a round trip time (RTT) of the downlink HARQ corresponds to a time of four slots, and the number of the downlink HARQ processes is 4.

Uplink HARQ timing is as follows. The terminal receives a downlink A/N and/or uplink scheduling information (which is scheduling information regarding a physical uplink data channel, for example, a UL grant) from the BS, and transmits a physical uplink shared channel (PUSCH) to the BS after one slot.

Upon receiving the PUSCH, the BS transmits one of a downlink A/N and/or uplink scheduling information, or both, to the terminal after one slot. In the FDD system according to an exemplary embodiment of the present invention, the uplink HARQ RTT corresponds to a time of four slots, and the number of the uplink HARQ processes is 4.

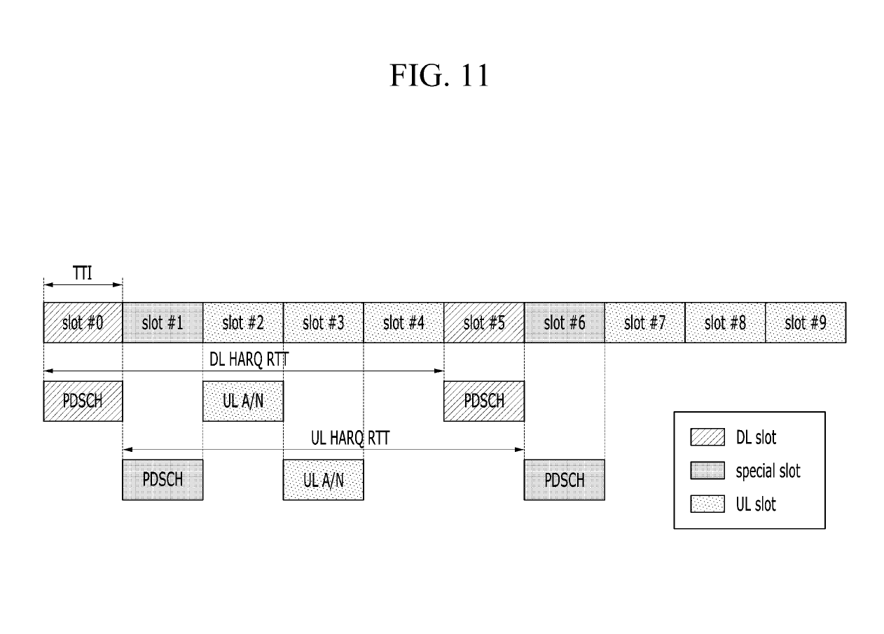

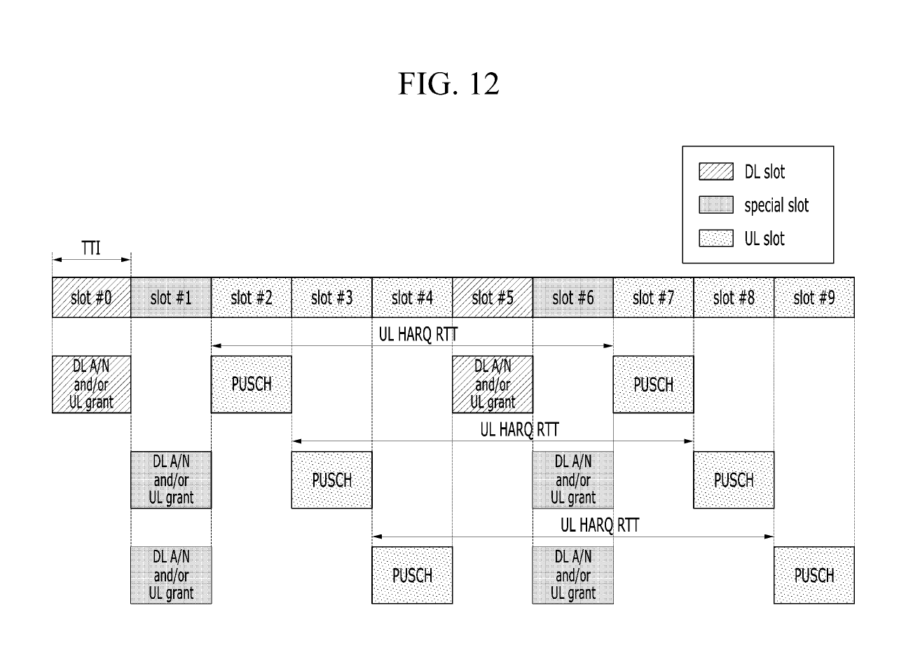

FIG. 11 is a view illustrating downlink HARQ timing of the TDD system according to an exemplary embodiment of the present invention, and FIG. 12 is a view illustrating uplink HARQ timing of the TDD system according to an exemplary embodiment of the present invention.

Referring to FIG. 11, the terminal receives a PDSCH from the BS, and transmits an uplink A/N to the BS after one slot. Upon receiving the uplink A/N from the terminal, the BS transmits a PDSCH to the terminal after two slots. Here, when the BS receives an uplink NACK, the BS may retransmit a PDSCH corresponding to the previously transmitted PDSCH. That is, in a case in which the uplink NACK is received by the BS, the PDSCH for correcting an error of the previously transmitted PDSCH may be transmitted from the BS to the terminal. Regardless of the slot (one of slot #0, slot #1, slot #5, and slot #6) in which the PDSCH according to an exemplary embodiment of the present invention is transmitted, the downlink HARQ timing of the TDD system follows the HARQ timing described above. In the TDD system according to an exemplary embodiment of the present invention, the downlink HARQ RTT corresponds to a time of five slots, and the number of downlink HARQ processes is 2.

Referring to FIG. 12, time intervals in which the PUSCH, the downlink A/N and/or the uplink scheduling information are transmitted may be different according to slots in which the PUSCH is transmitted. In a case in which the PUSCH is transmitted in slot #2, slot #3, slot #7, and slot #8, the terminal receives downlink A/N and/or uplink scheduling information from the BS and transmits a PUSCH to the BS after one slot. Upon receiving the PUSCH from the terminal, the BS transmits a downlink A/N and/or uplink scheduling information to the terminal after two slots. Alternatively, in a case in which the PUSCH is transmitted in slot #4 and slot #9, the terminal, which has received a downlink A/N and/or uplink scheduling information from the BS, transmits a PUSCH after two slots. Upon receiving the PUSCH from the terminal, the BS transmits a downlink A/N and/or uplink scheduling information to the terminal after one slot. In the TDD system according to an exemplary embodiment of the present invention, an uplink HARQ RTT corresponds to a time of five slots, and the number of uplink HARQ processes is 3.

In this manner, according to an exemplary embodiment of the present invention, a round trip time (RTT) of the AHRQ process may be shortened on the basis of the shortened length of the TTI, and thus a data transfer rate may be enhanced by as much.

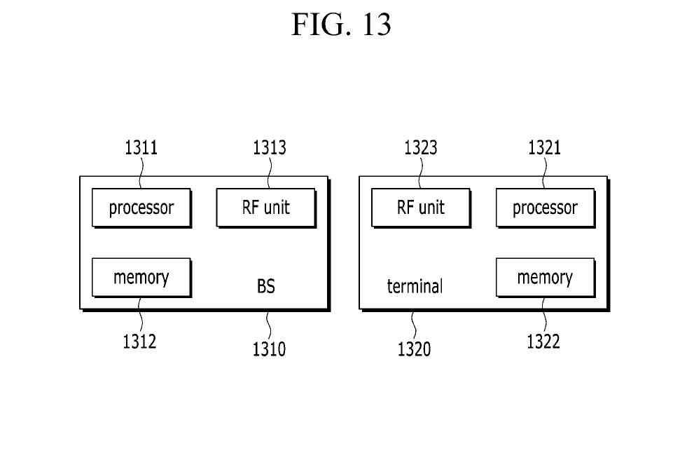

FIG. 13 is a block diagram illustrating a wireless communication system according to an exemplary embodiment of the present invention.

Referring to FIG. 13, the wireless communication system according to an exemplary embodiment of the present invention includes a base station 1310 and a terminal 1320.

The BS 1310 includes a processor 1311, a memory 1212, and a wireless communication unit (or a radio frequency (RF) unit)) 1313. The memory 1312 may be connected to the processor 1311 and store various types of information for driving the processor 1311 or at least one program executed by the processor 1311. The RF unit 1313 may be connected to the processor 1311 and transmit and receive a wireless signal to and from the processor 1311. The processor 1311 may implement the functions, processes, or methods proposed in an exemplary embodiment of the present invention. Here, in the wireless communication system according to an exemplary embodiment of the present invention, a wireless interface protocol layer may be implemented by the processor 1311. An operation of the BS 1310 according to an exemplary embodiment of the present invention may be implemented by the processor 1311.

The terminal 1320 includes a processor 1321, a memory 1322, and an RF unit 1323. The 1312 may be connected to the processor 1321 and store various types of information for driving the processor 1321. The RF unit 1323 may be connected to the processor 1321 and transmit and receive a wireless signal to and from the processor 1321. The processor 1321 may implement the functions, processes, or methods proposed in an exemplary embodiment of the present invention. Here, in the wireless communication system according to an exemplary embodiment of the present invention, a wireless interface protocol layer may be implemented by the processor 1321. An operation of the terminal 1320 according to an exemplary embodiment of the present invention may be implemented by the processor 1321.

In an exemplary embodiment of the present invention, the memories may be positioned within or outside of the processors, and may be connected to the processors through various known units. The memories may be various types of volatile or nonvolatile storage mediums, and may include, for example, a read-only memory (ROM) or a random access memory (RAM).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting a control channel of a terminal, the method comprising:
receiving information regarding a format of the control channel from a base station (BS) through higher layer signaling; and
transmitting the control channel to the BS through one slot on the basis of information regarding the format of the control channel,
wherein the control channel is mapped to at least one of a plurality of resource blocks positioned at both end portions of a system band.

2. The method of claim 1, wherein
the control channel mapped to each of a first resource block positioned at one end portion among both end portions of the system band and a second resource block positioned at the other end portion among both end portions of the system band.

3. The method of claim 1, wherein
the plurality of resource blocks are disposed in relatively same positions at both end portions of the system bandwidth in units of N number of resource blocks having continuous indices.

4. The method of claim 3, wherein
when the N is 2, relative positions of two resource blocks having continuous indices are determined according to whether the two resource blocks are of an even number or an odd number.

5. The method of claim 3, wherein,
on the basis of an index of an i-th resource block among the N number of resource blocks having continuous indices and a modulo operation of N, a relative position of the i-th resource block with respect to the N number of resource blocks is determined.

6. The method of claim 1, wherein
the transmitting comprises,
when reception performance of the control channel is poor, transmitting the control channel to the BS through one slot and a subsequent slot on the basis of information regarding a format of the control channel.

7. The method of claim 1, wherein
the receiving comprises
receiving information regarding a format of the control channel from the BS through radio resource control (RRC) signaling or system information.

8. A method for performing a hybrid automatic repeat request (HARQ) process by a terminal, the method comprising:
receiving a signal from a base station (BS) in a first slot among a plurality of slots included in a frame;
when the terminal operates in a frequency division duplex (FDD) system, performing a HARQ process of the FDD system on the signal in units of four slots among the plurality of slots; and
when the terminal operates in a time division duplex (TDD) system, performing a HARQ process of the TDD system on the signal in units of five slots among the plurality of slots

9. The method of claim 8, wherein
the performing of the HARQ process of the FDD system comprises:
when the signal is a first physical downlink shared channel (PDSCH), transmitting an uplink ACK or NACK to the BS in a second slot spaced apart from the first slot by one slot; and
after the uplink NACK is transmitted, receiving a second PDSCH corresponding to the first PDSCH in a third slot spaced apart from the second slot by one slot.

10. The method of claim 8, wherein
the performing of the HARQ process of the FDD system comprises:
when the first signal is a downlink ACK or NACK or uplink scheduling information, transmitting a PDSCH to the BS in a second slot spaced apart from the first slot by one slot; and
receiving a downlink ACK or NACK or uplink scheduling information from the BS in a third slot spaced apart from the second slot by one slot.

11. The method of claim 8, wherein
the performing of the HARQ process of the TDD system comprises:
when the first slot is a downlink slot or a special slot and the signal is a first PDSCH, transmitting an uplink ACK or NACK to the BS in a second slot spaced apart from the first slot by one slot; and
after the uplink NACK is transmitted to the BS, receiving a second PDSCH corresponding to the first PDSCH in a third slot spaced apart from the second slot by two slots.

12. The method of claim 11, wherein
when the first slot is a downlink slot, the third slot is a downlink slot, and when the first slot is a special slot, the third slot is also a special slot.

13. The method of claim 8, wherein
the performing of the HARQ process of the TDD system comprises:
when the first slot is a special slot and the signal is the downlink ACK or NACK or uplink scheduling information, transmitting the PUSCH to the BS in a second slot spaced apart from the first slot by one slot; and
receiving an uplink ACK or NACK or uplink scheduling information in a special slot positioned to be subsequent to the second slot.

14. The method of claim 8, wherein
the performing of the HARQ process of the TDD system comprises:
when the first slot is a downlink slot and the signal is the downlink ACK or NACK or uplink scheduling information, transmitting a PUSCH to the BS in a second slot spaced apart from the first slot by one slot; and
receiving a downlink ACK or NACK or uplink scheduling information in a downlink slot positioned to be subsequent to the second slot.
